(19) United States
(12) Patent Application Publication
(10) Pub. No.: US 2026/0081769 A1
(43) Pub. Date: Mar. 19, 2026

(54) Key pair generation

(71) Applicant: CHEQs Global Ltd, London (GB)

(72) Inventors: Richard Piacentini, Chonburi (TH); Keir Finlow-Bates, Satakunta (FI)

(21) Appl. No.: 19/327,853

(22) Filed: Sep. 12, 2025

(30) Foreign Application Priority Data
Sep. 18, 2024 (GB) 2413723.4

(51) Int. Cl. H04L 9/08; H04L 9/32

(52) U.S. Cl. CPC H04L 9/0863; H04L 9/085; H04L 9/0869; H04L 9/3231

(57) ABSTRACT

A method for generating a private key for an asymmetric key cryptography algorithm using a password, wherein the password can be changed without the private key changing is presented. The method has applications to blockchain wallets, digital signing, passkeys, and other identity and access management systems in which password changing is currently difficult or impossible. The method generates a first matching code for a first password to derive a private key, and when the first password is changed to be a second password, the first matching code is altered to a second matching code to maintain derivation of the same private key, and the first password may be discarded or forgotten.

### CROSS-REFERENCE TO RELATED APPLICATIONS

This application claims priority under 35 U.S.C. § 119(a)-(d) to the United Kingdom of Great Britain Patent Application No. 2413723.4, titled “Key pair generation” by Richard Piacentini and Keir Finlow-Bates, filed on 18 Sep. 2024, the entire contents of which are hereby incorporated by reference.

### BACKGROUND OF THE INVENTION

Many computer systems currently provide identity and access management (IAM) through a use of asymmetric key cryptography systems such as Rivest-Shamir-Adleman (RSA), digital signature algorithm (DSA), elliptic curve digital signature algorithm (ECDSA), and other public/private key infrastructure.

Identification may be provided through digitally signing an identification challenge, and a transaction may be authorized through digitally signing the transaction with a private key corresponding to a public key associated with an identity permitted to conduct the transaction.

For example, on blockchain systems such as Bitcoin and Ethereum, transactions transferring digital assets such as bitcoin (BTC), ether (ETH), or digital tokens such as ERC-20 fungible tokens and ERC-721 non-fungible tokens may only be approved through inclusion on the blockchain if the transaction is correctly digitally signed using a private key from which a public key and/or a blockchain address registered as owning the digital assets were derived.

As a result, software in the form of blockchain wallets, for example the Bitcoin Core software for Bitcoin or MetaMask for Ethereum, comprises key generation, management, and digital signing functionality to provide users with an ability to approve blockchain transactions, some of which may involve a transfer of millions or even billions of dollars' worth of digital assets. One known method for generating private keys comprises an initial generation of a “seed phrase”, a list of twelve or more words randomly selected from a dictionary, with each word providing a number of bits of entropy. Private keys are subsequently generated from the entropy of the seed phrase.

### SUMMARY OF THE INVENTION

It is imperative that blockchain wallets are secure and not vulnerable to hacking, and furthermore, mechanisms must be put in place to allow some measure of key retrieval in cases where the blockchain wallet is corrupted, a device on which it runs is irreparably damaged, or when the user forgets a password or personal identification number code (PIN code) for unlocking the wallet. Cases of private key compromization and loss have resulted in hundreds of millions if not billions of dollars' worth of digital assets being stolen or irretrievably lost, emphasizing the importance of good key management. For many wallets, the key retrieval mechanism consists of the simplistic approach of writing down the seed phrase on a piece of paper and storing it somewhere safe. This is not secure.

Current architectures for blockchain wallets often use a password to unlock the wallet. However, due to architectural restrictions, changing the password requires the wallet to be cleared and for the seed phrase to be retrieved from its safe storage place and re-entered. Taking the seed phrase from its secure location and entering twelve or twenty-four words correctly is not user-friendly.

There is therefore a strong need for a robust, reliable, and user-friendly key management system with passwords that can be changed. In the present disclosure, systems and methods are presented for a secure generation of private keys that may then be accessed using a simple password entry or biometric unlocking of the system, with the password being able to be changed.

In existing blockchain wallets, the user is presented with the randomly generated seed phrase or initial random number, and asked to record it, for example by writing it down on a piece of paper, store it securely, for example in a safe or locked draw in the event that the blockchain wallet password is forgotten, a blockchain wallet device develops a hardware fault, or other failure of the blockchain wallet. This imposes an extra burden on the user, who has to take extra steps beyond memorizing their blockchain wallet password, namely writing out by hand or printing out the seed phrase, and then storing it. In the present system, this burden is removed, providing superior functionality for the user.

A computer-implemented system for generating a password protected private key in which the password may be changed is disclosed.

The system may comprise at least one device comprising a hardware processor for retrieving and executing instructions for generating the private key from a password and a randomly generated number. A user of the system may subsequently change the password to a new password with the same private key being generated from the new password and the random number.

In some embodiments, a method for generating a private key may comprise: generating a master key number, obtaining the first password from a user, generating a first matching number, storing the master key number and the first matching number in a secure storage, applying a reversible function to the first password and the first matching number to obtain an unlocking number, generating the private key by applying a key derivation function to the master key number and the unlocking number, obtaining a second password from the user, obtaining an integrity measure associated with the second password; verifying whether the integrity measure is valid; and if the integrity measure is valid: applying an inverse of the reversible function to the unlocking number and the second password to obtain a second matching number and storing the second matching number in the secure storage for future use with provisions of the second password.

This method allows for increased security of blockchain data while also allowing for improved reliability and flexibility of access. In particular, the method allows for the user to access their securely-stored blockchain data (such as a blockchain wallet) using a password. The user is able to choose their password, ensuring it is memorable and secure, and later to change the password conveniently to ensure it remains secure. There is no need for the user to remember or record any random seeds or other complex data associated with private keys used within the blockchain itself. This in turn mitigates the risk of the user being led to record such complex data in an insecure manner such as writing it down.

It is further noted that users losing access to their securely stored data is likely to incur personal loss, as well as further computational work (such as, for example, further blockchain transactions) relating to the user attempting to recover their data. This further computation consumes processor and network resources that may be saved if the user is instead required only to remember a password. Systems and methods disclosed herein therefore have the further advantage of saving processor and network resources by avoiding the need for unnecessary work arising from forgetting security information.

Furthermore, increased security reduces the risk of a malicious third party successfully accessing the user's secured data due to, for example, finding security information stored in an unsafe manner. Instead, the user is able to maintain a memorable and (if they wish) regularly updated password that is less easily obtained by third parties. Systems and methods disclosed herein therefore have the further advantage of increased security and reduced vulnerability to malicious third parties.

In some embodiments, the master key number is generated randomly, and/or from a seed phrase. The seed phrase may be constructed by randomly selecting words from a dictionary, where a position of each word in the dictionary corresponds to a number of predetermined bits. For example, provided for illustrative purposes only and not meant to be limiting, the word “aardvark” may provide 00000000000 as eleven bits all equal to zero, and “zebra” may provide 11111111111 as eleven bits all equal to one, with words between “aardvark” and “zebra” providing all other combinations of bits.

Random and/or seed-based generation of the master key number has the advantage that the master key is more difficult for a malicious third party to predict or determine, thereby increasing security of the system.

In some embodiments, the first password and the second password may each comprise a string comprising alphanumeric and symbol characters, and the first password and second password may each be converted to a respective number.

Alphanumeric passwords are generally more memorable to users, thereby reducing the risk of a password being forgotten and access to secure data being lost.

In some embodiments, the first password and the second password may be made available through a biometric reader comprising one or more of: a fingerprint reader, a face recognition system, a voice recognition system, an iris recognition system, a retina recognition system, a palm reader, a vein pattern detector, a hand geometry scanner, and/or a hybrid biometric device.

The use of a biometric reader reduces the need for the user to remember their password, thereby further reducing the risk of access to data being lost.

In some embodiments, the secure storage may comprise one or more of: a hardware security module, a secure data enclave, and/or a trusted platform module.

The use of a dedicated secure storage device or software module reduces allows for increased security and reduces the risk of fraudulent access to the stored data.

In some embodiments, on obtaining the second password from the user, if the integrity measure is not valid, the method may be paused for a predetermined period of time and the first matching number may not be replaced with the second matching number in the secure storage.

In some embodiments, the first matching number may be deleted if integrity measure is valid, e.g. if the first password is correctly supplied by the user with the second password.

In some embodiments, the first password and/or the second password may comprise one or more of: a personal identification number, a fingerprint, a biometric reading, and/or a passkey.

In some embodiments, the reversible function may comprise one or more of: an exclusive OR function, a controlled NOT gate function, a Toffoli gate, a Fredkin gate, and/or a Quaternion multiplication with sets of bits of the first password and the second password mapped to a set of Quaternion base vectors.

In some embodiments, after generating the private key by applying a key derivation function to the master key number and the unlocking number, the unlocking number may be deleted.

In some embodiments, the unlocking number may be shared with one or more administrative entities. The unlocking number may be split into a plurality of shares using a secret sharing algorithm, and each of the plurality of shares may be shared with each of a plurality of administrative entities.

The secret sharing algorithm may comprise one or more of: a Shamir's secret sharing method, a Blakely's plane intersection scheme, and/or a Chinese remainder theorem secret sharing scheme.

The integrity measure may comprise the first password and may be received from the user.

In some embodiments, after the first password has been used to generate the first matching code, only the second password may be obtained from the user, and the first unlocking number may be regenerated using the first matching code and the master key, with the master key obtained from the one or more administrative entities.

In some embodiments, after the first password has been used to generate the first matching code, only the second password may be obtained from the user, and the first unlocking number may be regenerated using the first matching code and the master key, with the master key obtained from a sufficient threshold of shares from one or more of the one or more administrative entities.

In some embodiments, on generating the private key, a cryptographic hash of the private key is stored. Then, on receiving a third password from the user, a first unlocking key is produced using the third password and the first matching code and a a second unlocking key is generated using the third password and the second matching code. Then which of the first unlocking key and the second unlocking key generates the private key is determined by applying a key derivation function to the master key number and the first unlocking number and hashing to produce a first result, and applying the key derivation function is to the master key number and the second unlocking number and hashing to produce a second result. If the first result equals the cryptographic hash of the private key then the third password is required with the first matching code, and if the second result equals the cryptographic hash of the private key, then the third password is required with the second matching code. This provides a method for multiple passwords to be used.

According to a further aspect of the present disclosure there is provided a computer program product comprising program instructions that, when executed by a processor of a computing device, cause the processor to execute the above method.

According to a further aspect of the present disclosure there is provided a computing device for generating a private key, the computing device comprising a processor configured to: generate a master key number; obtain a first password from a user; generate a first matching number; store the master key number and the first matching number in a secure storage; apply a reversible function to the first password and the first matching number to obtain an unlocking number; generate the private key by applying a key derivation function to the master key number and the unlocking number; obtain a second password from the user; obtain an integrity measure associated with the second password; verify whether the integrity measure is valid; and if the integrity measure is valid: apply an inverse of the reversible function to the unlocking number and the second password to obtain a second matching number; and store the second matching number in the secure storage.

It will be appreciated that the functionality of the devices we describe may be divided across several modules. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), etc. The, or each processor may include one or more processing cores with each core configured to perform independently. The, or each processor may have connectivity to a bus to execute instructions and process information stored in, for example, a memory.

The invention further provides processor control code to implement the above-described systems and methods, for example on a general purpose computer system or on a digital signal processor (DSP). The invention also provides a carrier carrying processor control code to, when running, implement any of the above methods, in particular on a non-transitory data carrier-such as a disk, microprocessor, CD-or DVD-ROM, programmed memory such as read-only memory (Firmware), or on a data carrier such as an optical or electrical signal carrier. The code may be provided on a carrier such as a disk, a microprocessor, CD-or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

### BRIEF DESCRIPTION OF DRAWINGS

It is important to understand that the drawings included in this disclosure are provided solely for illustrative purposes and do not delineate the full scope of the present system. The figures are not necessarily drawn to scale; the relationships between objects in each figure may also not reflect accurate proportions. In some cases, the size, position, or other attributes of the objects may be reversed or otherwise altered to better illustrate the concept being described. The primary intention of these figures is to enhance comprehension and clarity regarding the structure of each depicted element. Consequently, certain features may be exaggerated or otherwise modified to highlight specific aspects of the structure more effectively.

Furthermore, the present system is elaborated upon in greater detail through these accompanying drawings. These illustrations are intended to demonstrate features of various illustrative embodiments, which may be combined or separated in whole or in part. Each drawing aims to provide a visual representation that supports the textual description, thereby offering a more complete understanding of the inventive concepts and their potential applications.

By way of example, the figures serve to visually explain aspects of the present system, showcasing different embodiments that highlight its versatility and adaptability. These drawings are an integral part of the disclosure, providing a means to visualize and contextualize the detailed descriptions provided herein. This approach ensures that the scope of the present system, as claimed, is fully understood, despite the illustrative nature of the figures.

FIG. 1 is a flowchart illustrating a method for generating a private key, public key, and blockchain address from a master key and a password.

FIG. 2 is a block diagram illustrating an exemplary system implementing the method of FIG. 1.

FIG. 3 is a flowchart illustrating a method for generating the private key, public key, and blockchain address from the master key and the password using an unlocking key.

FIG. 4 is a block diagram illustrating an exemplary system implementing the method of FIG. 3.

FIG. 5 is a flowchart illustrating a method for replacing a first unlocking key with a second unlocking such that the private key, public key, and blockchain address generated from the master key and a first password are the same as from the master key and a second password, thus allowing a user to change passwords.

FIG. 6 is a block diagram illustrating an exemplary system implementing the method of FIG. 5.

FIG. 7 is a diagram illustrating an exemplary method for implementing an initial matching code generator and a replacement matching code generator.

FIG. 8 shows an example communication system that may be used to implement methods disclosed herein.

### DETAILED DESCRIPTION OF THE INVENTION

The following disclosure describes illustrative embodiments that, in conjunction with the accompanying drawings, demonstrate the aforementioned features and advantages, as well as additional benefits. The subsequent description sets forth exemplary details, such as architecture, interfaces, techniques, and attributes, for purposes of explanation rather than limitation. It will be evident to those skilled in the art that other embodiments, differing from these details, are nonetheless within the scope of the appended claims. Additionally, for clarity, detailed descriptions of well-known devices, circuits, tools, techniques, and methods are omitted to avoid obscuring the description of the present system.

The term “and/or,” and its variations, should be understood to mean that one or more of the recited elements may be present (for example, only one recited element is present, two of the recited elements may be present, and so on, up to all of the recited elements may be present) in a system according to the claims and in accordance with one or more embodiments of the present system.

The system, device, method, arrangement, interface, computer program, artificial intelligence system, process, mechanical form, structure, linkages, and so forth, (hereinafter each of which will be referred to as system, or otherwise such as method, device, and so on, and should be understood to be interchangeable, unless the context indicates otherwise), described herein address problems in previous systems and offer advantages compared to said previous systems. Moreover, embodiments of the present system enhance the operation, efficiency, and reliability beyond those provided by the previous systems. For instance, by offering information on specific deficiencies, embodiments of the present system significantly improve efficiency over the previous systems and assist parties in addressing those deficiencies directly.

In aspects of the present disclosure, systems and methods are disclosed for generating a private key in a secure reproducible manner using one or more of: a password, a personal identification number code (PIN code), a biometric identification system such as a fingerprint reader or face scanner, an authenticator application, a passkey, and/or a passkey generator such as a YubiKey™ or mobile phone passkey application.

One function of blockchain wallets is the generation and secure storage of private keys, from which public keys are derived using an asymmetric key cryptography algorithm or some other digital signature algorithm, and subsequently a blockchain address. The blockchain address is usually constructed using an application of one or more rounds of one or more cryptographic hash functions. In some blockchain wallets, a seed phrase, consisting of a number of words randomly selected from a dictionary, is generated, with an index of each word corresponding to a number of bits, and the complete seed phrase therefore providing a sufficient number of randomly selected bits (either one or zero) to represent an initial random number. The initial random number can then be used as the private key, or a plurality of private keys can be generated by repeated applications of, for example, a cryptographic hash function or a key derivation function to the initial random number.

In existing blockchain wallets, the user is presented with the randomly generated seed phrase or initial random number, and asked to record it, for example by writing it down on a piece of paper, store it securely, for example in a safe or locked draw in the event that the blockchain wallet password is forgotten, a blockchain wallet device develops a hardware fault, or other failure of the blockchain wallet. This imposes an extra burden on the user, who has to take extra steps beyond memorizing their blockchain wallet password, namely writing out by hand or printing out the seed phrase, and then storing it. In the present system, this burden is removed, providing superior functionality for the user.

In the present disclosure we use the term password to signify an input to the methods and embodiments disclosed, thus password may also cover a PIN code, a passkey, or a biometrically unlocked code. In an exemplary embodiment provided for illustrative purposes only and not meant to be limiting in any way, providing a password may also be read as providing a first PIN code or a first fingerprint, and changing the password to a new password may also be read as changing from using the first PIN code to using a second PIN code or changing from using the first fingerprint to using a second fingerprint. This flexibility is not available in the state of the art for blockchain wallets.

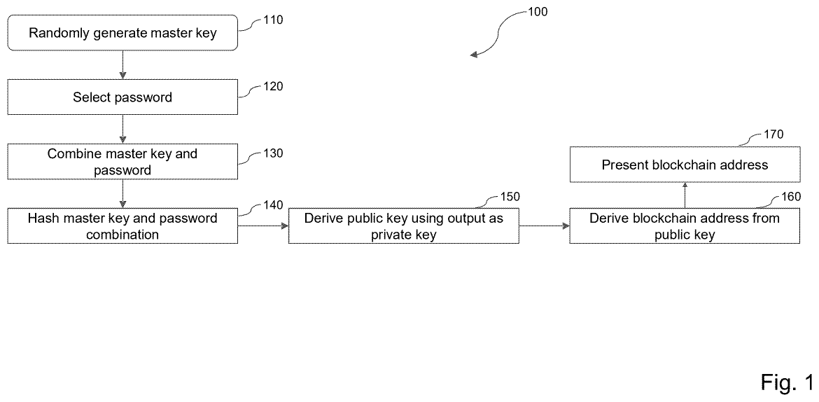

In accordance with embodiments of the present system, a method 100 for deriving a blockchain address from a master key and a password is presented in FIG. 1. Actions may commence with a generation of a master key through a random process, for example but not limited to one or more of: a pseudo-random number generator, entropy input from a user, a quantum random number generator, or some other random number generation method, as shown in step 110.

Actions may then proceed to step 120, in which a password may be selected. In some embodiments the password may be converted to a number.

Actions may then proceed to step 130, in which some or all of the master key and some or all of the password may be combined, for example, through concatenation, through multiplication, through multiplication modulo a predetermined number, or through some other combination method, producing a master key and password combination.

Actions may then proceed to step 140, in which the master key and password combination may optionally be hashed using a cryptographic hash function, producing an output. In some embodiments the produced master key and password combination may comprise the output without application of the cryptographic hash function.

Actions may then proceed to step 150, in which a public key may be derived using a digital signing algorithm public key derivation algorithm and using the output as a private key input to the digital signing algorithm public key derivation algorithm.

Actions may then proceed to step 160, in which a blockchain address may be derived from the public key. Those skilled in the art will appreciate that there are many blockchain address derivation methods depending on which blockchain is used. For example, in Ethereum the public key may be hashed with a Keccak256 cryptographic hash function, and a last 20 bytes of an output of the Keccak256 cryptographic hash function may comprise an Ethereum address corresponding to the public key.

Actions may then proceed to step 170, in which the blockchain address may be presented, for example but not limited to, as part of a quick response code (QR code) that may be scanned by a payee for crypto asset payments to the blockchain address.

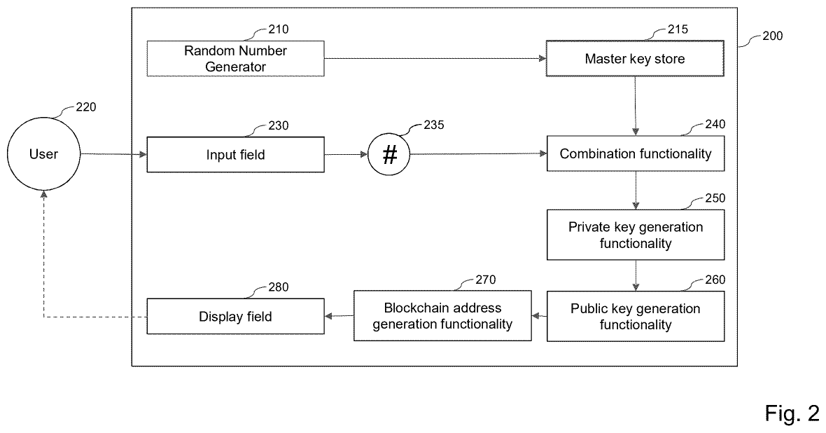

FIG. 2 presents a block diagram illustrating an exemplary system implementing the method of FIG. 1, presented for illustrative purposes only and not meant to be limiting in any way. A device 200 may comprise a random number generator 210, for example, a pseudo-random number generator (PRNG) or a quantum random number generator (QRNG). When a user 220 of the device wishes to generate a blockchain address, the random number generator 210 may generate a random number henceforth known as the master key. The master key may be stored in a master key store 215 (otherwise referred to herein as secure storage), which in some embodiments may comprise a hardware security module or other secure data storage area. The master key store 215 is denoted with a bold rectangle to indicate secure storage.

The term secure storage is used herein to mean any storage, implemented as hardware or software, that is capable of storing data and comprises a protective measure that protects against unauthorized access (such as e.g. password protection, data encryption, and/or tamper-proofing through physical or electromagnetic radiation shielding).

The device may then prompt the user 220 for a password through, for example but not limited to, an input field 230. In some embodiments, the input field 230 may comprise a component of a web page or mobile application. The device 200 may then hash the password provided through the input field 230 using a conversion function 235. In some embodiments the conversion function 235 may comprise a cryptographic hash function, or may convert the password to a number using some other method, for example taking a binary representation of the password when denoted in ASCII or Unicode.

The output from the conversion function 235 and the master key as retrieved from the master key store 215 may then be combined using combination functionality 240. In an embodiment of the present system, the combination functionality may comprise generating a concatenation of the output from the conversion function 235 with the master key and optionally a salt. Those skilled in the art will now appreciate that there are many methods for combining two inputs to obtain a suitable output, and should note that the aforementioned example of the conversion function 235 is provided for illustrative purposes only and is not meant to be limiting in any way.

The output of the combination functionality 240 may then be provided to private key generation functionality 250, for example but not limited to applying a cryptographic hash function one or more times, to produce an output comprising the private key. At this point the system is able to repeatedly produce the same private key from the master key and the password input provided the correct password is supplied each time by the user.

The output of the private key generation functionality 250 may then be passed to the public key generation functionality 260 to generate a public key for the private key. Public key generation from a private key is well-known in the field of asymmetric key cryptography. For example but not meant to be limiting in any way, if the output of the private key generation functionality 250 is a 256 bit number, using an elliptic curve digital signing algorithm (ECDSA) and a secp256k1 elliptic curve, a corresponding ECDSA public key may be generated.

The public key may then be passed to a blockchain address generation functionality 270 to generate a blockchain address from the public key. For example, provided for illustrative purposes only and not meant to be limiting, the blockchain address generation functionality 270 may hash the public key with the cryptographic hash function Keccak256 and return a string comprising “0x” concatenated with a hexadecimal representation of the last 20 bytes of the cryptographic hash function output. In some embodiments, the blockchain address may then be displayed to the user 220 using a display field 280.

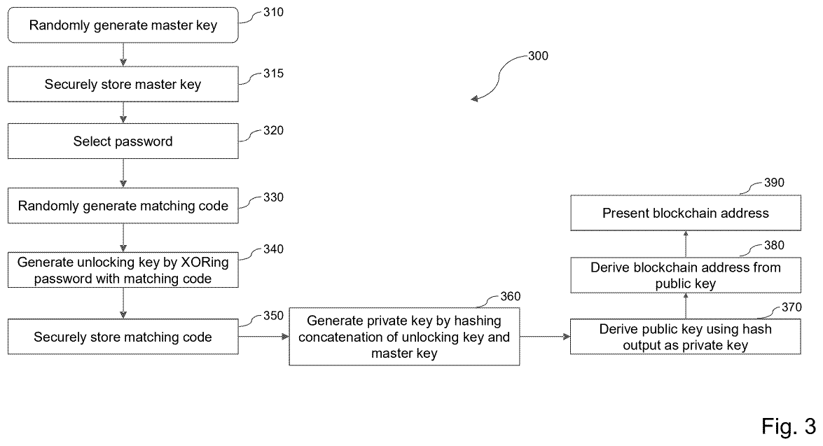

In accordance with embodiments of the present system, in FIG. 3 a method 300 for deriving a blockchain address from a master key, a password, and a matching code is presented. Actions may commence with a generation of a master key through a random process, for example but not limited to one or more of: a pseudo-random number generator, entropy input from a user, a quantum random number generator, or some other random number generation method, as shown in step 310.

Actions may then proceed to step 315, in which the master key may be stored in secure storage, which in some embodiments may comprise a hardware security module or other secure data storage area.

Actions may then proceed to step 320, in which a password may be selected. In some embodiments the password may be converted to a number.

Actions may then proceed to step 330, in which a matching code is generated through a random process. The random process may be one or more of those described in step 310.

Actions may then proceed to step 340, in which an unlocking key is generated by applying a reversible function to the password and the matching code. We define a function f as being reversible if f(x, y)=z implies that there exists an inverse of f, henceforth denoted f′, namely given x and z we can obtain y, that is f′(x, z)=y, and given y and z we can obtain x, that is f′(y, z)=x. Examples of reversible functions suitable for the present invention, presented for illustrative purposes only and not meant to be limiting in any way, include bit-level exclusive or (XOR), bitwise-rotation exclusive-or (ROXR), controlled negation (CNOT), and/or three bit-level functions such as a Quaternion group operation, for example but not limited to assigning bit triplets as 000=1, 001=−1, 010=i. 011=−i, 100=j, 101=−j, 110=k, and 111=−k, thus translating each bit triplet to a basis vector, then using Quaternion multiplication, followed by translating a Quaternion multiplicative result back to a bit triplet. Those skilled in the art will now appreciate that there are many such functions, for example, any non-Abelian group with an order equal to 2^{b} where b is the number of bits considered in turn provides reversible functions for a basis element set that can be mapped to from the set of possible b bits. (i.e. for Quaternions, b=3, as the associated group has order 8). For simplicity and purposes of illustration, not meant to be limiting in any way, XOR is used as the reversible function, however any reversible function will suffice.

Actions may then proceed to step 350, in which the matching code may be stored in secure storage, which in some embodiments may comprise a hardware security module or other secure data storage area.

Actions may then proceed to step 360, in which a private key is generated from some or all of the master key and some or all of the matching code being combined, for example, through concatenation, through multiplication, through multiplication modulo a predetermined number, or through some other combination method, producing a master key and unlocking key combination. In some embodiments the master key and matching code combination may be hashed using a cryptographic hash function to produce the private key. In some embodiments the master key and matching code combination may comprise the private key without application of the cryptographic hash function.

Actions may then proceed to step 370, in which a public key may be derived using a digital signing algorithm public key derivation algorithm and using the the private key as an input to a digital signing algorithm public key derivation algorithm.

Actions may then proceed to step 380, in which a blockchain address may be derived from the public key as described in step 160 of FIG. 1.

Actions may then proceed to step 390, in which the blockchain address may be presented, for example but not limited to, as described in step 170 of FIG. 1.

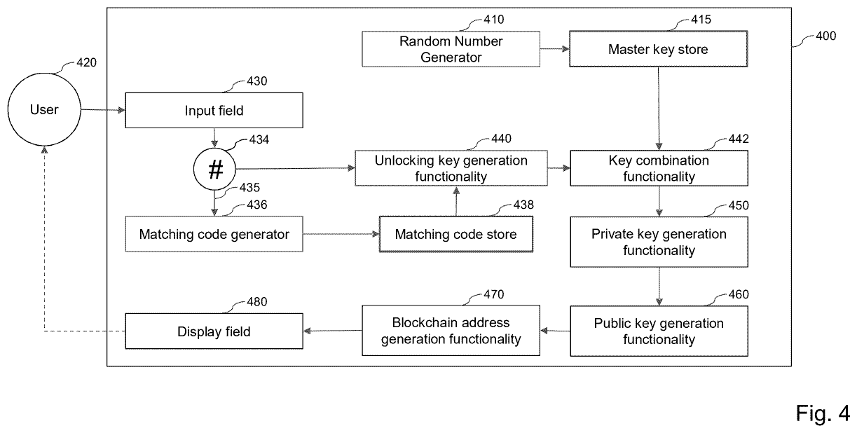

FIG. 4 presents a block diagram illustrating an exemplary system implementing the method of FIG. 3, presented for illustrative purposes only and not meant to be limiting in any way. A device 400 may comprise a random number generator 410, for example, a pseudo-random number generator (PRNG) or a quantum random number generator (QRNG). When a user 420 of the device wishes to generate a blockchain address, the random number generator 410 may generate a random number henceforth known as the master key. The master key may be stored in a master key store 415, which in some embodiments may comprise a hardware security module or other secure data storage area. The master key store 415 is denoted with a bold rectangle to indicate secure storage.

The device may then prompt the user 420 for a password through, for example but not limited to, an input field 430. In some embodiments, the input field 430 may comprise a component of a web page or mobile application.

The device 400 may then hash the password provided through the input field 430 using a conversion function 434. In some embodiments the conversion function 434 may comprise a cryptographic hash function, or may convert the password to a number using some other method, for example taking a binary representation of the password when denoted in ASCII or Unicode.

Entering a password into the input field 430 and/or the conversion function 434 converting the password may trigger a matching code generator 436, as shown by arrow 435, to generate a matching code, which in some embodiments may be randomly generated. The matching code may then be stored in secure storage in the form of a matching code store 438.

The output from the conversion function 434 and the matching code as retrieved from the matching code store 438 may then be combined using unlocking key generation functionality 440 to produce an unlocking key. In an embodiment of the present system, the unlocking key functionality may comprise applying a reversible function to the matching code and the conversion of the password, as described in step 340 of FIG. 3.

The output of the unlocking key generation functionality 440 may then be provided to a key combination functionality 442 together with the master key retrieved from the master key store 415, for example but not limited to, through concatenation, through multiplication, through multiplication modulo a predetermined number, or through some other combination method, producing a master key and unlocking key combination.

The output of the key combination functionality 442 may then be passed to a private key generation functionality 450 to generate a private key. The private key generation functionality 450 may, for example but not limited to, comprise applying a cryptographic hash function one or more times to the output of the key combination functionality 442, to produce an output comprising the private key. At this point the system is able to repeatedly produce the same private key from the master key and the matching code, provided the correct password is supplied each time by the user.

The output of the private key generation functionality 450 may then be passed to the public key generation functionality 460 to generate a public key for the private key. Public key generation from a private key is well-know in the field of asymmetric key cryptography. For example but not meant to be limiting in any way, if the output of the private key generation functionality 450 is a 256 bit number, using an elliptic curve digital signing algorithm (ECDSA) and a secp256k1 elliptic curve, a corresponding ECDSA public key may be generated.

The public key may then be passed to a blockchain address generation functionality 470 to generate a blockchain address from the public key. For example, provided for illustrative purposes only and not meant to be limiting, the blockchain address generation functionality 470 may hash the public key with the cryptographic hash function Keccak256 and return a string comprising “0x” concatenated with a hexadecimal representation of the last 20 bytes of the cryptographic hash function output to produce an externally owned account number on Ethereum. In some embodiments, the blockchain address may then be displayed to the user 420 using a display field 480.

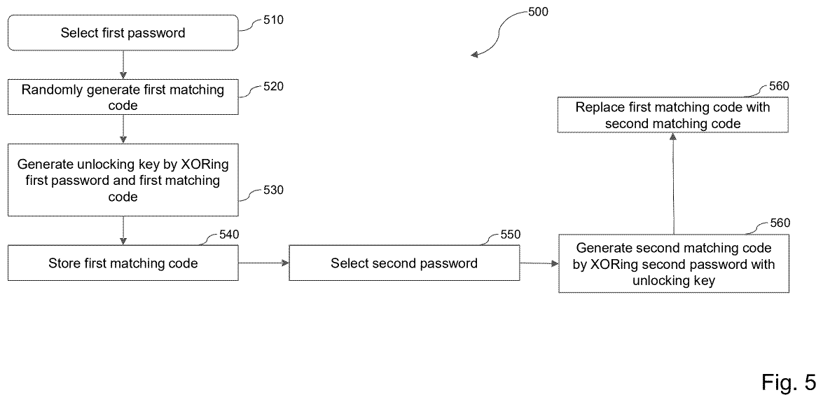

In accordance with embodiments of the present system, in FIG. 5 a method 500 for replacing a first matching code with a second matching code to allow a user to change their password from a first password to a second password is presented. Actions may commence with a user selecting a first password, as shown in step 510.

Actions may then proceed to step 520, in which a first matching code is randomly generated.

Actions may then proceed to step 530, in which an unlocking key is generated by applying the reversible XOR function to the first password with the first matching code. In other embodiments a different reversible function than XOR may be used, however for illustrative purposes and without limitation or loss of generality in the present disclosure we will use XOR, as those skilled in the art will now appreciate that the method will function equally well with another suitable reversible function.

Actions may then proceed to step 540, in which the first matching code may be stored, for example, in secure storage, which in some embodiments may comprise a hardware security module or other secure data storage area

Actions may then proceed to step 550, in which the user may select a second password to replace the first password.

Actions may then proceed to step 560, in which the second matching code may be generated by XORing the second password with the unlocking key. In some embodiments, the unlocking key may not be stored on the device or indeed anywhere, and the user may be required to provide the first password such that the unlocking key can be derived from the first password and the first matching code retrieved from the secure storage. In other embodiments the unlocking key may be stored by a trusted third party or may be broken into portions using a key sharing algorithm and may be stored by a plurality of trusted third parties, allowing the second matching code to be generated without the first password by the user requesting a password reset from the trusted third party or plurality of trusted third parties.

Actions may then proceed to step 560, in which the first matching code in the secure storage may be replaced with the second matching code. With the first matching code deleted or overwritten the first password will then no longer work with the second matching key to generate the unlocking key, and the second password with the second will generate the unlocking key. Thus the first password is obsoleted, and the second password becomes active.

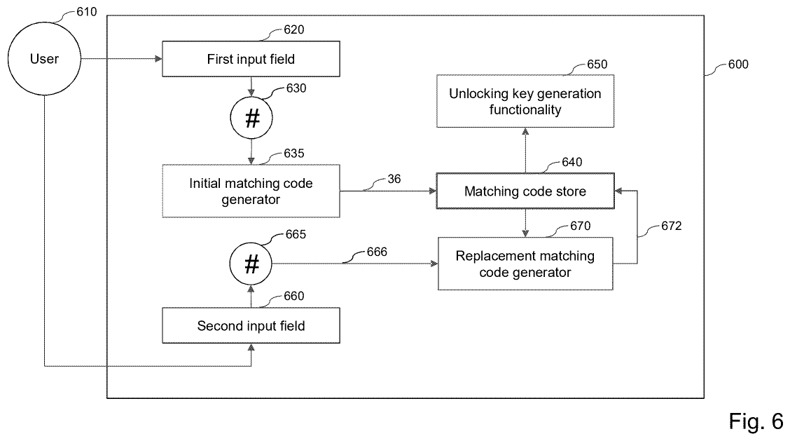

FIG. 6 presents a block diagram illustrating an exemplary system implementing the method of FIG. 5, presented for illustrative purposes only and not meant to be limiting in any way. A device 600 may prompt a user 610 for a first password through, for example but not limited to, a first input field 620. In some embodiments, the first input field 620 may comprise a component of a web page or mobile application.

The device 600 may then hash the first password provided through the first input field 620 using a first conversion function 630. In some embodiments the first conversion function 630 may comprise a cryptographic hash function, or may convert the first password to a number using some other method, for example taking a binary representation of the first password when denoted in ASCII or Unicode.

Entering the first password into the first input field 620 and/or the first conversion function 630 converting the first password may trigger an initial matching code generator 635 to generate a first matching code, which in some embodiments may be randomly generated. The first matching code may then be stored in secure storage in the form of a matching code store 640.

The output from the first conversion function 630 and the first matching code as retrieved from the matching code store 640 may then be combined using unlocking key generation functionality 650 to produce an unlocking key. In an embodiment of the present system, the unlocking key functionality may comprise applying a reversible function to the first matching code and the conversion of the first password, as described in step 340 of FIG. 3.

Subsequently, the device 600 may prompt the user 610 for a second password through, for example but not limited to, a second input field 660. In some embodiments the second input field 660 may be the first input field 620.

The device 600 may then hash the second password provided through the second input field 660 using a second conversion function 665. In some embodiments the second conversion function 665 may comprise a cryptographic hash function, or may convert the second password to a number using some other method, for example taking a binary representation of the second password when denoted in ASCII or Unicode. In some embodiments the second conversion function 665 may be the first conversion function 630.

Entering the second password into the second input field 660 and/or the second conversion function 665 converting the second password may trigger a replacement matching code generator 635 to generate a second matching code. The second matching code may then be stored in secure storage in the form of a matching code store 640, and in some embodiments replacing the first matching code. The replacement matching code may be generated using a reversible function applied to the output of the second conversion function 665 and the unlocking key. In some embodiments, the unlocking key may be generated on the fly by requiring the user to provide the first password with the second password, and using the output of the first conversion function 630 and the first matching code as inputs to the reversible function to re-generate the unlocking key.

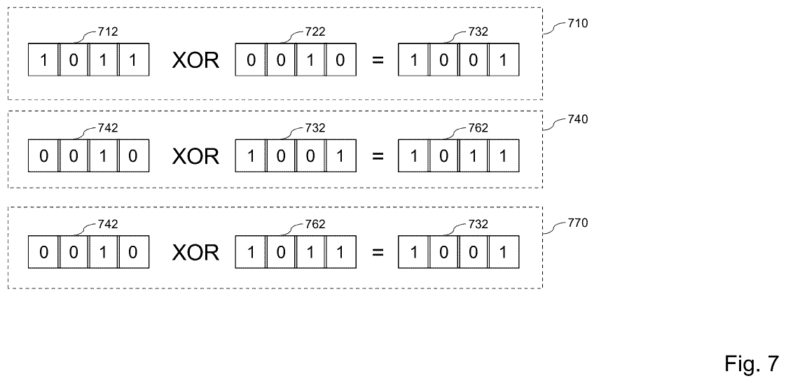

In FIG. 7 a block diagram providing a practical example provided for illustrative purposes only and not meant to be limiting in any way demonstrates how passwords and matching codes may be determined to produce the same unlocking key, using XOR and distinct values as an exemplary reversible function.

In block 710 a first password 712 selected by the user with a binary value of 1011 is XORed with a randomly generated matching code 722 with a binary value of 0010 to produce the unlocking key 732 with a binary value of 1001. From this point, the unlocking key 732 remains fixed.

In block 740 a user may select a second password 742 with a binary value of 0010. To compute a second matching code 762 that will generate the unlocking key 732 value, the system XORs the second password 742 with the unlocking key 732 to obtain the second matching code 762 with a binary value of 1011. This succeeds because XOR is a reversible function.

In block 770 the user may provide the second password 742 which, when XORed with the second matching code 762 may be readily seen to produce the unlocking key 732.

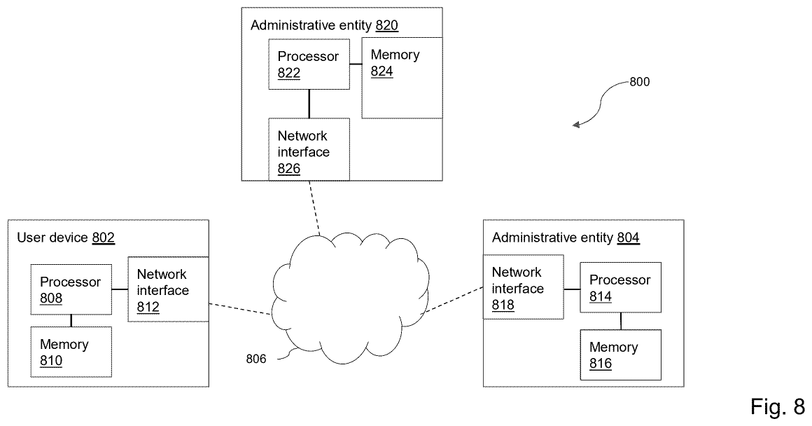

In an embodiment of the present system, the first password may be changeable by the user to the second password without presenting the first password to the system, but by presenting the unlocking key to the system instead. In an exemplary embodiment presented for illustrative purposes and not meant to be limiting in any way, the unlocking key may be shared with one or more administrative entities 804, 820 (as described below with reference to FIG. 8), and on a request from the user the administrative entities 804, 820 may provide the system with the unlocking key. In some embodiments, the unlocking key may be shared with a plurality of administrative entities 804, 820 through a key splitting algorithm, for example but not limited to Shamir's secret sharing algorithm or some other secret sharing algorithm, such that each administrative entity 804, 820 receives a share of the unlocking key, but no one of the plurality of administrative entities 804, 820 may regenerate the unlocking key from their share. Provided a sufficient number of the plurality of administrative entities 804, 820 provide their share, the unlocking key may subsequently be regenerated, and using the unlocking key and the second password provided by the user, the second matching key may be generated and stored in the system. Those skilled in the art will now appreciate that, in light of the previous disclosure, password reset functionality for a blockchain wallet through one or more administrators is described. In some embodiments the unlocking key and/or each share may be encrypted with a corresponding public key of each of the one or more of administrative entities.

The present invention may be implemented in various computing environments. The system may be embodied in hardware, software, or a combination of both. In a typical hardware configuration, the invention can be implemented using a general-purpose computer or any other specialized computing device. This general-purpose computer may include, but is not limited to, a central processing unit (CPU), a graphics processing unit (GPU), a network interface, input/output (I/O) interfaces, memory, storage devices, and peripheral devices.

FIG. 8 shows an example communication system 800 that may be used to implement methods disclosed herein. The system 800 comprises a user device 802, and optionally further comprises a plurality of administrative entities 804, 820. The user device and the administrative entities 804, 820 may communicate via a network 806.

The user device 802 may comprise a processor 808, a memory 810 operable to store program instructions and other information, and a network interface 812 configured to enable to the processor 808 to communicate via the network 806.

The user device 802 may correspond to any of the devices 200, 400, and 600 described above. In particular, the processor 808 may be configured to perform any of the methods disclosed herein. The user device may be operated by a user 220, 420, 610. The memory 810 may correspond to the master key store 215, 415 described above, otherwise referred to herein as the secure storage.

While FIG. 8 shows the memory 810 as being contained within the user device 802, in other implementations the memory 810 may be a remote memory that is outside the user device 802 and accessible to the processor 808, for example via the network 806.

Each of the administrative entities 804, 820 may comprise a respective computing device as shown in the figure, which each device comprising a respective processor 814, 822, memory 816, 824, and network interface 818, 826.

The administrative entities 804, 820 may be configured as described above to provide an unlocking key and/or respective shares of an unlocking key, in addition or as an alternative to the user re-entering the first password in order to change their password.

While FIG. 8 shows two administrative entities 804, 820, in embodiments there may be more than two administrative entities.

A typical computing device 802 suitable for implementing the invention includes one or more processors 808, such as a CPU, that execute instructions stored in a memory 810. The memory 810 may include volatile and non-volatile memory types, such as RAM, ROM, EEPROM, flash memory, or other suitable memory technologies. The device 802 may also comprise one or more storage devices, such as hard drives, solid-state drives, or other persistent storage mediums, which store data and executable instructions for the software implementation of the invention.

The computing device 802 may further include various input and output interfaces, such as a keyboard, mouse, touchscreen, or other input devices for user interaction. Output interfaces may include display devices like monitors or screens, printers, or other output peripherals. Network interfaces 812 may be incorporated to enable the device to connect and communicate over wired or wireless networks, facilitating data exchange and remote operations.

In addition to the primary hardware components, the computing device 802 may include various peripheral devices that enhance functionality, such as cameras, sensors, additional storage devices, and specialized hardware components. Communication between the different components of the system, including peripheral devices, is typically managed via buses or other communication protocols, ensuring seamless operation and integration.

Some embodiments of the present system may be implemented as software that may be executed within an operating system environment, which manages the hardware resources and provides services for the execution of applications. The software may be developed using various programming languages and may run as standalone applications, web-based applications, or as part of a distributed system. The software modules may interact with the hardware components through system calls, function calls, APIs, and other interfaces provided by the operating system and hardware drivers.

The described hardware configuration is illustrative and not restrictive. The system can be implemented on a wide range of hardware platforms, from small embedded systems to large-scale distributed computing environments. Each embodiment may involve different combinations of hardware and software components, tailored to meet specific requirements and operational contexts.

Some embodiments of the present system may use a cryptographic hash function, which may be one or more of, or a combination of, but not limited to: MD5, SHA-1, RIPEMD-160, Whirlpool, SHA-2, SHA-3, BLAKE, BLAKE2, BLAKE3, Keccak256, and/or some other cryptographic hash function.

Some embodiments of the present system may use a reversible function, which may be one or more of, or a combination of, but not limited to: an exclusive OR function, a controlled NOT gate function, a Toffoli gate, a Fredkin gate, and/or a Quaternion multiplication with sets of bits of the first password and the second password mapped to a set of Quaternion base vectors, and/or some other reversible function.

Although the present system has been described with a limited number of embodiments, it should be understood that modifications can be made without departing from the scope of the original claimed system. All content in the foregoing specification and drawings is intended to be illustrative rather than exclusive. The discussion here is meant to exemplify the present system and should not be interpreted as restricting the appended claims to any specific embodiment or group of embodiments. Therefore, even though the present system has been discussed with reference to exemplary embodiments, it should be recognized that numerous modifications, combinations, sub-combinations, and alternative embodiments may be conceived by those skilled in the art without departing from the broader spirit and intended scope of the present system as outlined in the claims. Furthermore, any section headings included are for convenience and do not limit the scope of the present system. Consequently, the specification and drawings should be regarded as illustrative and not as limitations on the scope of the appended claims.

When interpreting the specification and appended claims, it should be understood that the term “including” does not exclude the presence of other elements or actions beyond those listed in a given description or claim. The use of “a” or “an” before an element does not exclude the presence of multiple such elements. Multiple “means” may be represented by the same item or by hardware or software implemented structure or function. Any disclosed elements may include hardware components (for example, discrete and integrated electronic circuitry and/or analogue circuitry), software components (for example, computer programs and/or instructions), and/or any combination thereof. Hardware components may include both analogue and digital portions. Disclosed devices or portions thereof can be combined or separated into further portions unless specifically stated otherwise. No specific sequence of acts or steps is required unless explicitly indicated. The term “plurality of” an element includes two or more of the claimed elements and does not imply any specific range; it can be as few as two elements or an immeasurable number of elements. The term “and/or” and its variations should be understood to mean that one or more of the listed elements may need to be present in the system in accordance with the description and/or claim recitation and one or more embodiments of the present system.

1. A computer-implemented method for generating a private key, the method comprising:
generating a master key number;
obtaining a first password from a user;
generating a first matching number;
storing the master key number and the first matching number in a secure storage;
applying a reversible function to the first password and the first matching number to obtain an unlocking number;
generating the private key by applying a key derivation function to the master key number and the unlocking number;
obtaining a second password from the user;
obtaining an integrity measure associated with the second password;
verifying whether the integrity measure is valid; and
if the integrity measure is valid: applying an inverse of the reversible function to the unlocking number and the second password to obtain a second matching number; and
storing the second matching number in the secure storage.

2. The method of claim 1, wherein the master key number is generated randomly.

3. The method of claim 1, wherein the master key number is generated from a seed phrase.

4. The method of claim 1, wherein the first password and the second password each comprise a string comprising alphanumeric and symbol characters, and the first password and second password are each converted to a respective number.

5. The method of claim 4, wherein the first password and the second password are made available through a biometric reader comprising one or more of: a fingerprint reader, a face recognition system, a voice recognition system, an iris recognition system, a retina recognition system, a palm reader, a vein pattern detector, a hand geometry scanner, and/or a hybrid biometric device.

6. The method of claim 1, wherein the secure storage comprises one or more of: a hardware security module, a secure data enclave, and/or a trusted platform module.

7. The method of claim 1, wherein on obtaining the second password from the user, if the integrity measure is not valid, the method is paused for a predetermined period of time and the first matching number is not replaced with the second matching number in the secure storage.

8. The method of claim 1, further comprising deleting the first matching number if the integrity measure is valid.

9. The method of claim 1, wherein the first password and/or the second password comprise one or more of: a personal identification number, a fingerprint, a biometric reading, and/or a passkey.

10. The method of claim 1, wherein the reversible function comprises one or more of: an exclusive OR function, a controlled NOT gate function, a Toffoli gate, a Fredkin gate, and/or a Quaternion multiplication with sets of bits of the first password and the second password mapped to a set of Quaternion base vectors.

11. The method of claim 1, wherein after generating the private key by applying a key derivation function to the master key number and the unlocking number, the unlocking number is deleted.

12. The method of claim 1, wherein the unlocking number is shared with one or more administrative entities.

13. The method of claim 12, wherein the unlocking number is split into a plurality of shares using a secret sharing algorithm, and wherein each of the plurality of shares is shared with a respective one of a plurality of administrative entities.

14. The method of claim 1, wherein the integrity measure comprises the first password and is received from the user.

15. The method of claim 12, wherein the integrity measure comprises the unlocking number and is received from one or more of the one or more administrative entities.

16. The method of claim 13, wherein the integrity measure comprises the unlocking number, and wherein obtaining the integrity measure comprises obtaining a sufficient threshold of shares from one or more of the one or more administrative entities, and generating the unlocking number from the sufficient threshold of shares.

17. The method of claim 13, wherein the secret sharing algorithm comprises one or more of: Shamir's secret sharing, Blakely's plane intersection scheme, and/or Chinese remainder theorem secret sharing.

18. The method of claim 1, further comprising:
after generating the private key, storing a cryptographic hash of the private key;
receiving a third password from the user;
generating a first unlocking key using the third password and the first matching code and generating a second unlocking key using the third password and the second matching code; and
verifying which of the first unlocking key and the second unlocking key generate the private key by applying a key derivation function to the master key number and the first unlocking number and to the master key number and the second unlocking number.

19. A computer program product comprising program instructions that, when executed by a processor of a computing device, cause the processor to execute the method of claim 1.

20. A computing device for generating a private key, the computing device comprising a processor configured to:
generate a master key number; obtain a first password from a user;
generate a first matching number;
store the master key number and the first matching number in a secure storage;
apply a reversible function to the first password and the first matching number to obtain an unlocking number;
generate the private key by applying a key derivation function to the master key number and the unlocking number;
obtain a second password from the user;
obtain an integrity measure associated with the second password;
verify whether the integrity measure is valid; and
if the integrity measure is valid: apply an inverse of the reversible function to the unlocking number and the second password to obtain a second matching number and store the second matching number in the secure storage.
